(19) United States
(12) Patent Application Publication
(10) Pub. No.: US 2026/0103071 A1
(43) Pub. Date: Apr. 16, 2026

(54) CLUTCH ASSIST MODIFICATION SYSTEM FOR REDUCING PEDAL ACTUATION FORCE

(71) Applicant: Enrique Gonzalez Cruz, Caguas, PR (US)

(72) Inventor: Enrique Gonzalez Cruz, Caguas, PR (US)

(21) Appl. No.: 19/358,347

(22) Filed: Oct. 14, 2025

Related U.S. Application Data
(60) Provisional application No. 63/706,889, filed on Oct. 14, 2024.

(51) Int. Cl. B60K 23/02

(52) U.S. Cl. CPC B60K 23/02

(57) ABSTRACT

A retrofit clutch assist system enables installation of a later model clutch assist spring and perch onto an earlier vehicle without permanent modification. The system includes a hook assembly mounted to the clutch and brake pedal assembly and a pedal support plate fastened to the steering column. These components hold the clutch assist mechanism in functional alignment, reducing clutch pedal effort by about 20 pounds while preserving original pedal travel.

### CROSS REFERENCE TO RELATED APPLICATIONS

This application claims priority from a U.S. Provisional Patent Appl. No. 63/706,889, filed on Oct. 14, 2024, which is incorporated herein by reference in its entirety.

### FIELD OF INVENTION

The present invention relates generally to vehicle clutch systems and, more particularly, to a retrofit clutch assist mechanism for vehicles not originally equipped with a clutch assist feature, including 2007 Ford Mustang GT.

### BACKGROUND

In conventional manual transmission vehicles, a clutch pedal is mechanically linked to a clutch assembly for disengaging and engaging the transmission during gear shifting. The force required to actuate the clutch pedal may be substantial, especially in high-performance vehicles such as the Ford Mustang GT. Prolonged operation in traffic or during performance driving can result in driver fatigue and reduced comfort.

Existing solutions to reduce pedal force typically require replacement or modification of the clutch pedal assembly, drilling into structural components, or installation of external pneumatic or hydraulic assist devices. Such modifications can be invasive, costly, and may compromise the integrity of the vehicle's structure.

Accordingly, there is a need for a non-invasive clutch assist modification that effectively reduces pedal effort without requiring permanent alteration of the original clutch or brake pedal assemblies.

### SUMMARY OF THE INVENTION

The following provides a simplified summary of one or more embodiments of the present invention to facilitate a basic understanding of its features and advantages. This summary is not an exhaustive overview of all contemplated embodiments and is not intended to identify essential elements or define the full scope of the invention. It merely introduces certain concepts that are described in greater detail in the subsequent sections.

The present invention is directed to a clutch assist modification assembly configured to reduce clutch pedal actuation force by approximately 20 pounds.

Still another object of the present invention is that no modification to clutch pedal and brake pedal assembly is required.

Yet another object of the present invention is that no drilling is required for retrofitting.

In one aspect, the assembly comprises a hook assembly and a pedal support plate that cooperates to provide mechanical assist to the clutch actuation.

In another aspect, the assembly includes a hook assembly and a pedal support plate configured to mount directly to the base of the clutch pedal and brake pedal assembly and to the steering column structure, respectively.

In another aspect, the modification can be installed without any drilling, welding, or alteration to the clutch pedal and brake pedal assembly, thereby preserving the OEM configuration while enhancing clutch operation.

The assist mechanism applies a counteracting force during pedal depression, thereby reducing the net pedal force required by the driver while maintaining tactile feedback and engagement control.

In another aspect, the assembly further includes a clutch assist spring and a perch which are included in latest models of vehicles but not present in old models, thereby providing assist functionality on the earlier vehicle without modifying the original pedal assembly.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is an isometric view of an assembled hook of the assembly, according to an exemplary embodiment of the present invention.

FIG. 2 illustrates a side view of the assembled hook, according to an exemplary embodiment of the present invention.

FIG. 3 illustrates a hook portion of the assembled hook, according to an exemplary embodiment of the present invention.

FIG. 4 illustrates a plate portion of the assembled hook, according to an exemplary embodiment of the present invention.

FIG. 5 illustrates a perspective view of a pedal support plate, according to an exemplary embodiment of the present invention.

FIG. 6 illustrates a side view of the pedal support plate, according to an exemplary embodiment of the present invention

FIG. 7 illustrates another side view of the pedal support plate, according to an exemplary embodiment of the present invention.

### DETAILED DESCRIPTION

The subject matter of the present invention will now be described more fully with reference to the accompanying drawings, which form a part of this disclosure and illustrate specific exemplary embodiments. However, it should be understood that the subject matter may be embodied in various forms and is not limited to the specific embodiments set forth herein. Rather, these embodiments are provided by way of example to convey the scope of the invention. It is intended that the claims encompass a broad range of subject matter, including methods, devices, components, and systems. Accordingly, the following detailed description is not intended to be taken in a limiting sense.

As used herein, the term “exemplary” is intended to mean “serving as an example, instance, or illustration.” Any embodiment described as “exemplary” should not be construed as preferred or more advantageous over other embodiments. Similarly, the expression “embodiments of the present invention” does not imply that all embodiments must include all features, advantages, or modes of operation described.

The terminology used herein is for the purpose of describing particular embodiments only and is not intended to be limiting. As used herein, the singular forms “a,” “an,” and “the” include plural references unless the context clearly dictates otherwise. Furthermore, the terms “comprises,” “comprising,” “includes,” and/or “including” specify the presence of stated features, integers, steps, operations, elements, or components, but do not preclude the presence or addition of one or more other features, integers, steps, operations, elements, components, and/or groups thereof.

The following detailed description sets forth the best currently contemplated modes for carrying out exemplary embodiments of the invention. This description is not intended to be limiting, but rather to illustrate the general principles of the invention. The claims of any issued patent will define the scope of the invention.

The invention described pertains to a clutch assist assembly for vehicles. Disclosed is a clutch assist assembly for a 2007 Ford Mustang GT and similar vehicles. The disclosed clutch assist assembly can make the pressing of the clutch softer compared to original equipment. This helps overcome the fatigue caused by repeated pressing of hard clutches. The disclosed assembly can be particularly useful in congested traffic situations and long drives including touring. The disclosed clutch assist assembly can be retrofitted without requiring any major modifications, such as drill holes.

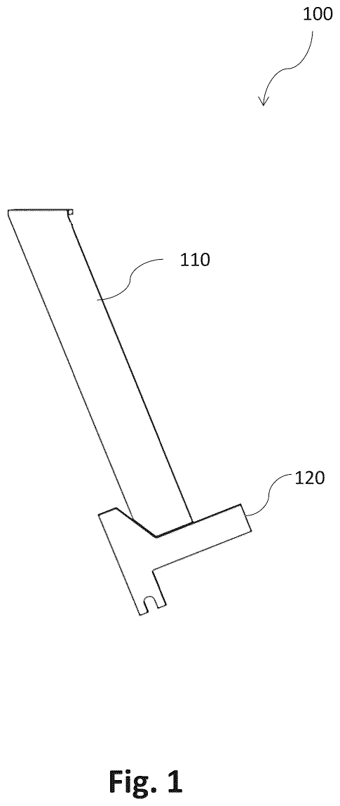

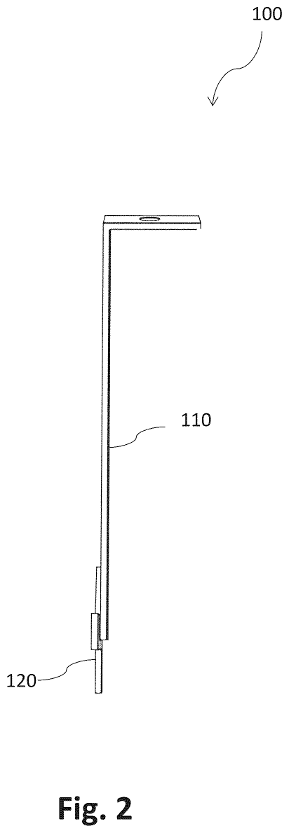

Referring to FIGS. 1 and 2, which show different views of the assembled hook 100 of the disclosed clutch assists assembly. This assembled hook 100 can attach to the lower or base region of the clutch pedal and brake pedal assembly. The assembled hook 100 includes a formed profile adapted to receive and retain the factory assist spring perch used on the Ford mustang 2014 model or any suitable spring perch. The geometry of the assembled hook 100 provides stable alignment with the clutch pedal lever, allowing proper preload of the assist spring.

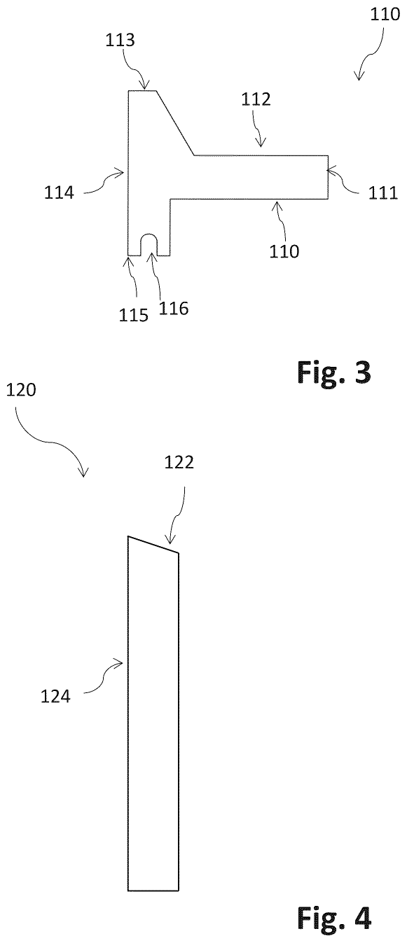

The assembled hook 100 includes a hook portion 110 shown in FIG. 3 and a plate portion 120 shown in FIG. 4. The hook portion 110 can be coupled to a proximal edge 122 of the plate portion 120. As shown in FIG. 4, the proximal edge 122 of the plate portion 120 is not perpendicular to the side edge 124 but the longer side edge 124 and the proximal edge 122 are aligned at 68° angle. The dimension of this long side edge 124 may be about 6.785 inches. The hook portion 110 is of a substantially T-shape profile referred to herein as having a head portion and a tail portion. The head portion and the tail portion of the hook portion 110 may be manufactured internally. In the hook portion 110, a first side 111 has a dimension of about 0.53 inches, a second side 112 has a dimension of about 1.66 inches, a third side 113 has a dimension of about 0.375 inches, a fourth side 114 has a dimension of about 1.850 inches, and a fifth side 115 has a dimension of about 0.530 inches. The head portion also has a cutout 116 along the fifth side 115. The width of this cutout 116 may be about 0.200 inches.

The hook portion is secured to the clutch elements using screw fasteners at existing attachment points. This configuration eliminates the need for structural modification and enables precise positioning of the assist mechanism.

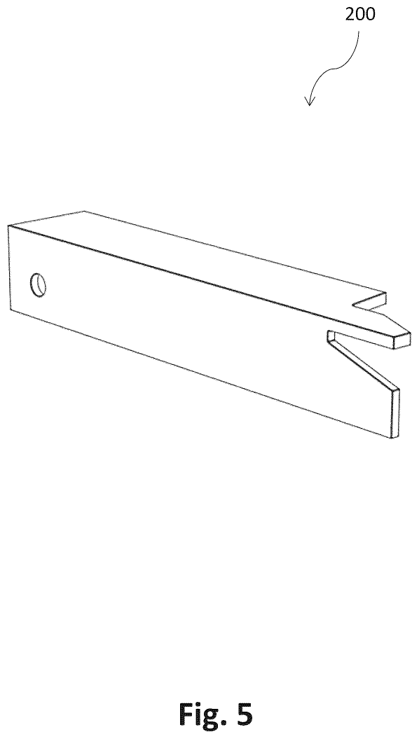

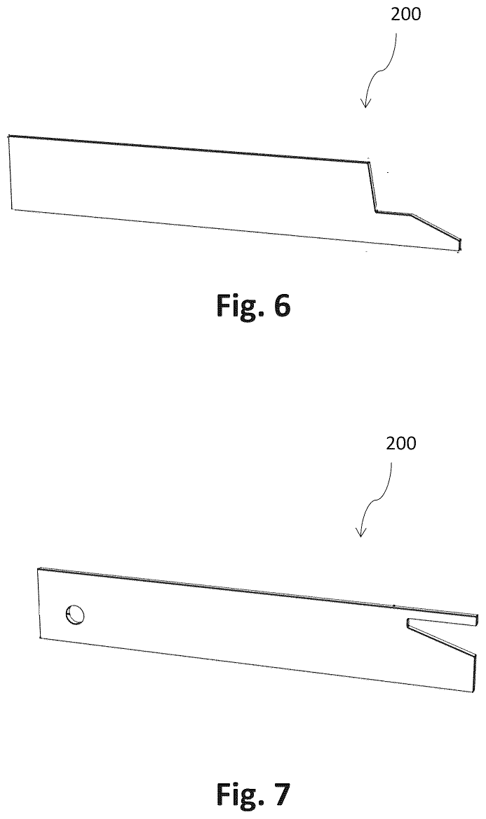

Referring to FIGS. 5, 6, and 7, which show different views of the pedal support plate 200. The pedal support plate can 200 be fastened to the steering column structure. The support plate 200 provides a rigid anchor point that stabilizes the hook and perch assembly during pedal operation. The notched region of the support plate 200 engages with the assembled hook 100, distributing load forces and ensuring proper alignment under cyclic pedal actuation.

The assembled hook 100 and the pedal support plate 200 cooperate to hold a 2014 Ford mustang GT clutch assist spring and perch in functional alignment with the 2007 Ford mustang GT clutch assembly. When the driver depresses the clutch pedal, the assist spring stores a portion of the pedal force, reducing the net effort required at the pedal pad. Upon release, the stored energy is returned to assist pedal return motion.

In a preferred embodiment, the retrofit clutch assist assembly reduces the clutch pedal actuation force by approximately 20 pounds, measured at the pedal pad. This reduction is achieved without altering the clutch pedal travel or engagement characteristics.

The assembly is reversible and can be removed without damage to the vehicle. It uses OEM components from the 2014 Ford mustang GT model and simple mechanical fasteners, making it suitable for DIY or professional installation.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A retrofit clutch assist assembly for a manual transmission vehicle comprising:
an assembled hook configured to attach to a base portion of a clutch and brake pedal assembly of the vehicle; and
a pedal support plate configured to mount to a steering column structure of the manual transmission vehicle.

2. The retrofit clutch assist assembly of claim 1, further comprising:
a spring perch and assist spring, wherein the assembled hook and the pedal support plate are arranged to hold the spring perch and assist spring in functional alignment with the clutch pedal.

3. The retrofit clutch assist assembly of claim 1, wherein the assembly hook comprises a T-shape hook portion and a plate portion.

4. A method for retrofitting a clutch assist assembly for a manual transmission vehicle comprising:
attaching an assembled hook to a base portion of a clutch and brake pedal assembly of the vehicle; and
mounting a pedal support plate to a steering column structure of the manual transmission vehicle.

5. The method of claim 4, wherein the clutch assist assembly comprises:
a spring perch and assist spring, wherein the assembled hook and the pedal support plate are arranged to hold the spring perch and assist spring in functional alignment with the clutch pedal.

6. The method of claim 4, wherein the assembly hook comprises a T-shape hook portion and a plate portion.
